(19) United States
(12) Patent Application Publication
(10) Pub. No.: US 2025/0267316 A1
(43) Pub. Date: Aug. 21, 2025

(54) SYSTEM FOR CONTEXTUAL SEARCHING USING CONTENT SEARCH TERMS

(71) Applicant: ANOKI, INC., San Carlos, CA (US)

(72) Inventors: Susmita Ghose, Mountain View, CA (US); Sartaki Sinha Roy, Uttarpara (IN); Ashutosh Chaubey, Chhattisgarh (IN)

(73) Assignee: ANOKI, INC., San Carlos, CA (US)

(21) Appl. No.: 18/581,330

(22) Filed: Feb. 19, 2024

(51) Int. Cl. H04N 21/234; H04N 21/25

(52) U.S. Cl. CPC H04N 21/23424; H04N 21/23418; H04N 21/251

(57) ABSTRACT

A system for contextual searching of content based on a content query. The content is related to multimodal metadata extracted from the content. A search vector is created using a compatible metadata extractor and the distance between said search vector and an embedding is indicative matching the content to the search content. The search content may be broken out by scene and the embedding for each scene may be established independently to serve as search terms, which may be combined trough logical combinations.

### CROSS-REFERENCE TO RELATED APPLICATIONS

This application is related to U.S. application Ser. No. ______ filed on ______, 2023, attorney docket no. 169003; U.S. application Ser. No. ______ filed on ______, 2023, attorney docket no. 169004; U.S. application Ser. No. ______ filed on ______, 2023, attorney docket no. 169006; U.S. application Ser. No. ______ filed on ______, 2023, attorney docket no. 169007; U.S. application Ser. No. ______ filed on ______, 2023, attorney docket no. 169008; U.S. application Ser. No. ______ filed on ______, 2023, attorney docket no. 169009; and U.S. application Ser. No. ______ filed on ______, 2023, attorney docket no. 169010; the disclosures of all of which are incorporated by reference herein.

### BACKGROUND OF THE INVENTION

### 1. Field of the Invention

The invention relates to a video content processing system and more

particularly to a content-based search of contextual data representing video content.

### 2. Description of the Related Technology

Online advertising is a form of marketing and advertising that uses the Internet to promote products and services to audiences and platform users. Advertisements are increasingly being delivered via automated software systems operating across multiple websites, media services, and platforms, known as programmatic advertising.

Online advertising often involves a publisher, who integrates advertisements into its online content, and an advertiser, who provides the advertisements to be displayed on the publisher's content. Other potential participants include advertising agencies that help generate and place the ad copy, and an ad server that delivers and tracks the advertising activity.

Many common online advertising practices are controversial and, as a result, have become increasingly subject to regulation. Many internet users also find online advertising disruptive and have increasingly turned to ad blocking for a variety of reasons. Online ad revenues also may not adequately replace other publishers' revenue streams.

Display advertising conveys its advertising message visually using text, logos, animations, videos, photographs, or other graphics. The goal of display advertising is to obtain more traffic, clicks, or popularity for the advertising brand or organization. Display advertisers frequently target users to increase the ads' effect.

Web banners or banner ads typically are graphical ads displayed within a web page. Many banner ads are delivered by a central ad server.

The online advertising process may involve many parties. In the simplest case, the website publisher selects and serves the ads. Publishers which operate their own advertising departments may use this method. Alternatively, ads may be outsourced to an advertising agency, and served from the advertising agency's servers or ad space may be offered for sale in a bidding market using an ad exchange and real-time bidding, known as programmatic advertising.

Programmatic advertising involves automating the sale and delivery of digital advertising on websites and platforms via software rather than direct human decision-making. Advertisements are selected and targeted to audiences via ad servers which often use cookies, which are unique identifiers of specific computers, to decide which ads to serve to a particular consumer. Cookies can track whether a user left a page without buying anything, so the advertiser can later retarget the user with ads from the site the user visited.

As advertisers collect data across multiple external websites about a user's online activity, they can create a detailed profile of the user's interests to deliver even more targeted advertising. This aggregation of data is called behavioral targeting. Advertisers also target their audience by using contextual cues to deliver ads related to the content of the web page where the ads appear. Retargeting, behavioral targeting, and contextual advertising all are designed to increase an advertiser's return on investment over untargeted ads.

Customer information is combined and returned to the supply-side

platform creates and provides ad offers to an ad exchange. The ad exchange puts the offer out for bid to demand-side platforms. Demand-side platforms act on behalf of ad agencies that sell ads. Demand-side platforms have ads ready to display and are searching for users to view them. Bidders get the information about the user ready to view the ad and decide, based on that information, how much to offer to buy the ad space. An ad exchange picks the winning bid and informs both parties. The ad exchange then passes the link to the ad back through the supply side platform and the publisher's ad server to the user's browser, which then requests the ad content from the agency's ad server.

Interstitial ads: An interstitial ad displays before a user can access requested content, sometimes while the user is waiting for the content to load. Interstitial ads are a form of interruption marketing.

Content marketing is any marketing that involves the creation and sharing of media and publishing content to acquire and retain customers. This information can be presented in a variety of formats, including blogs, news, videos, white papers, e-books, infographics, case studies, how-to guides, and more.

Ad blocking, or ad filtering is a technology that may be used to block advertising.

An online advertising network or ad network is a company that connects advertisers to websites that want to host advertisements. The key function of an ad network is an aggregation of ad supply from publishers and matching it with the advertiser's demand. The phrase “ad network” by itself is media-neutral in the sense that there can be a “Television Ad Network” or a “Print Ad Network” but is increasingly used to mean “online ad network” as the effect of aggregation of publisher ad space and sale to advertisers is common in the online space. The fundamental difference between traditional media ad networks and online ad networks is that online ad networks use a central ad server to deliver advertisements to consumers (ad serving), which enables targeting, tracking, and reporting of impressions in ways not possible with analog media alternatives.

Targeted networks focus on specific targeting technologies such as behavioral or contextual, that have been built into an ad server. Targeted networks specialize in using consumer clickstream data to enhance the value of the inventory they purchase. Further specialized targeted networks include social graph technologies which attempt to enhance the value of inventory using connections in social networks. Significant targeting methods include behavioral targeting, contextual targeting, and creative optimization by using experimental or predictive methods to explore the optimum creative for a given ad placement and exploiting that determination in further impressions.

Artificial intelligence (AI) is the intelligence of machines or software, as opposed to the intelligence of human beings or animals.

Machine learning is the study of programs that can improve their performance on a given task automatically. It has been a part of AI from the beginning.

There are several kinds of machine learning. Unsupervised learning analyzes a stream of data, finds patterns, and makes predictions without any other guidance. Supervised learning requires a human to label the input data first and comes in two main varieties: classification (where the program must learn to predict what category the input belongs in) and regression (where the program must deduce a numeric function based on numeric input). In reinforcement learning the agent is rewarded for good responses and punished for bad ones. The agent learns to choose responses that are classified as “good”. Transfer learning is when the knowledge gained from one problem is applied to a new problem. Deep learning uses artificial neural networks for these types of learning.

Natural language processing (NLP) allows programs to read, write, and communicate in human languages such as English. Specific problems include speech recognition, speech synthesis, machine translation, information extraction, information retrieval, and question answering.

Modern deep learning techniques for NLP include word embedding (how often one word appears near another), transformers (which finds patterns in text), and others. Feature detection helps AI compose informative abstract structures out of raw data.

Machine perception is the ability to use input from sensors (such as cameras, microphones, wireless signals, active lidar, sonar, radar, and tactile sensors) to deduce aspects of the world. Computer vision is the ability to analyze visual input. The field includes speech recognition, image classification, facial recognition, object recognition, and robotic perception.

Deep learning uses several layers of neurons between the network's inputs and outputs. The multiple layers can progressively extract higher-level features from the raw input. For example, in image processing, lower layers may identify edges, while higher layers may identify the concepts relevant to a human such as digits, letters, or faces.

Generative artificial intelligence (AI) is artificial intelligence capable of generating text, images, or other media, using generative models. Generative AI models learn the patterns and structure of their input training data and then generate new data that has similar characteristics. A generative AI system is constructed by applying unsupervised or self-supervised machine learning to a data set. The capabilities of a generative AI system depend on the modality or type of the data set used.

A foundation model (also called base model) is a large machine learning (ML) model trained on a vast quantity of data at scale (often by self-supervised learning or semi-supervised learning) such that it can be adapted to a wide range of downstream tasks. Foundation models can in turn be used for task and/or domain-specific models using targeted datasets of various kinds. Beyond text, several visual and multimodal foundation models have been produced—including DALL-E, Flamingo, Florence, and NOOR. Visual foundation models (VFMs) have been combined with text-based LLMs to develop sophisticated task-specific models. There is also Segment Anything by Meta AI for general image segmentation. For reinforcement learning agents, there is GATO by Google DeepMind.

Foundation models may be further developed through additional training. A foundation model is a “paradigm for building AI systems” in which a model trained on a large amount of unlabeled data can be adapted to many applications. Foundation models are “designed to be adapted (e.g., finetuned) to various downstream cognitive tasks by pre-training on broad data at scale”.

Key characteristics of foundation models are emergence and homogenization. Because training data is not labeled by humans, the model emerges rather than being explicitly encoded. Properties that were not anticipated can appear. For example, a model trained on a large language dataset might learn to generate stories of its own or to do arithmetic, without being explicitly programmed to do so. Furthermore, these properties can sometimes be hard to predict beforehand due to breaks in downstream scaling laws. Homogenization means that the same method is used in many domains, which allows for powerful advances but also the possibility of “single points of failure”.

### SUMMARY OF THE INVENTION

It is an object to provide a system that is computationally efficient yet allows for a deep understanding of content, including video and/or other content.

It is an object to provide a versatile system that may be used in different applications where machine understanding of content, including video and/or other content, is useful or required.

It is an object to provide a system capable of indexing content, including video and/or other content, according to multiple domains. It is a further object to provide a system where the indexing of video may be on a scene-by-scene basis and/or a frame-by-frame basis.

It is an object to utilize artificial intelligence (AI) techniques to generate the index of content, including video and/or other content. It is a further object to provide a system that extracts scene and frame-level detail from content, including video and/or other content as the content is streamed. It is a further object to provide a system that extracts scene and frame-level detail from content, including video and/or other content, for storage in an embedding database in the form of AI indexing vectors.

It is a further object to generate a query that can be used to search the database. It is yet a further object to generate a search query from content, including video and/or other content, and in particular from an image or video input to search the embeddings of content, including video and/or other content, on a scene-by-scene or a frame-by-frame basis. The search query may be used to search an index database and/or to examine a video content stream. In the context of the system, a match between a search vector and video content is based on the distance between the query embedding and the content embedding.

According to an advantageous feature, a multimodal metadata extraction system may be provided with a scene detector having a video content input and an output representing scene boundaries. The metadata extractor may be responsive to the content of a scene as identified by the scene boundaries to extract metadata corresponding to several, plural, or multiple extraction modes. A metadata embedding may be used for each of the modes.

An embedding aggregator response to the embedding operates to formulate an aggregated embedding for each scene thereby indexing the content of the scene. The output representing the identified scenes may be a set of video clips of each scene or an index to the video content corresponding to the identified scenes. The scene detector may include a frame analyzer for identifying consecutive frames having similar characteristics. A boundary detector may be provided to identify boundaries of consecutive frames having sufficiently similar characteristics that they likely belong to the same shot. An embedding system may be provided to formulate a composite distance matrix capturing the distance between shot embeddings. A temporal clustering system may be connected to the composite distance matrix. An output of the temporal clustering system identifies the scene boundaries of the content.

An embedding database may be connected to the embedding aggregator for storing the aggregated embedding for use as a search index for scenes identified in the content.

The multimodal metadata extraction system may be provided with extraction modes to adequately characterize the content. The particular extraction modes and a number of extraction modes may be in accordance with the application for which the metadata will be used. Extraction modes include at least one of audio (speech recognition, music recognition); image recognition (feature recognition with temporal understanding); text (caption, scene summarization, text recognition); and scene interpretation (sentiment, profanity, action level). Many other extraction modes may be implemented.

Various other objects, features, aspects, and advantages of the disclosed system will become more apparent from the following detailed description of preferred embodiments of the invention, along with the accompanying drawings in which the same numerals represent the same components across more than one figure.

Moreover, the above objects and advantages are illustrative, and not exhaustive, of those that can be achieved by the or with the system. Thus, these and other objects and advantages will be apparent from the description herein, both as embodied herein and as modified in view of any variations that will be apparent to those skilled in the art.

### BRIEF DESCRIPTION OF THE DRAWINGS

FIG. 1 shows a multimedia metadata extraction system.

FIG. 2 shows the operation of a scene detector.

FIG. 3 shows a text-based query system.

FIG. 4. shows an embodiment using video content to search metadata extracted from video content using a multimodal metadata extractor.

### DETAILED DESCRIPTION OF THE PREFERRED EMBODIMENT

Before the present invention is described in further detail, it is to be understood that the invention is not limited to the embodiments described, as such may, of course, vary. It is also to be understood that the terminology used herein is for the purpose of describing embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges may independently be included in the smaller ranges are also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, a limited number of exemplary methods and materials are described herein.

It must be noted that as used herein and in the appended claims, the singular forms “a”, “an”, and “the” include plural referents unless the context clearly dictates otherwise.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates, which may need to be independently confirmed.

A system is provided for processing video content to gain a rich understanding of the video content. In order to effectively process the content and achieve sufficient computational efficiency, even using artificial intelligence (AI) techniques, a content stream may be divided into scenes made up of one or more segments of the content. Each segment is likely to correspond to a shot and is made up of one or more sequential frames having a high level of commonality. Two or more segments having a high level of commonality may be grouped together and processed as a single scene.

In content production, a “shot” is typically considered to be a continuous view captured by a single camera without interruption. A processor can identify continuous frames that are likely to be in the same groups of frames in a shot by examining local color distribution. These shots are identified as a segment of content. Similar shots (or segments) may be grouped into scenes. Similar shots are taken to be part of a scene. Shots having sufficient similarity in a scene are assumed to convey a homogeneous storyline or concept.

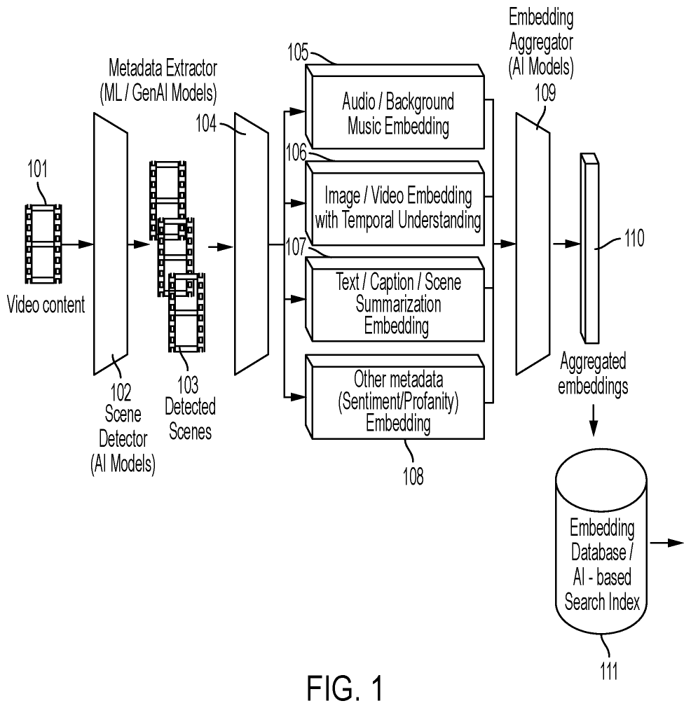

FIG. 1 shows a multimodal metadata extraction system with a video content input 101. The content input 101 is provided to a scene detector 102. The scene detector 102 operates to break a video content stream to smaller (or shorter) scenes. A video stream is made up of a series of frames. Frames of content can be grouped into segments based on commonality. Segments can also be grouped into scenes based on commonality.

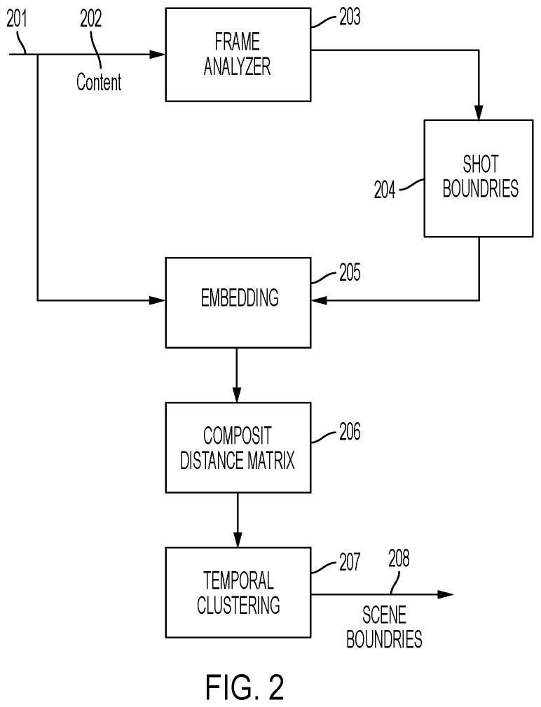

FIG. 2 shows the operation of scene detector 102. A content stream is provided to a stream analyzer for performing a frame-by-frame analysis to identify boundary frames for a series of consecutive frames having a high level of similarity. The frame-by-frame analysis may be performed by using significant average color distribution differences between consecutive frames. The shot boundaries may be stored in boundary table 204 and used to access the frames of a shot. The video content may be in content storage 206. Alternatively, the frames of a shot may be processed in a stream.

The frames of the shots are provided to embedding system 205. The embedding system may be implemented using a convolutional neural network or a Vision Transformer based on a Deep Learning image featurizer. The embedding system may generate a composite distance matrix 206 by capturing the distance between shot embedding based on a distance metric and potentially the temporal distance between shots.

Temporal clustering 207 based on dynamic programming is applied on the composite distance matrix 206 to group similar, shots together to obtain scene boundaries 208.

Scene boundaries 208 define the detected scenes 103. The detected scenes 103 are provided to a metadata extractor 104. The metadata extractor 104 considers the content of the scenes individually according to selected aspects anticipated to be potentially present in the content. FIG. 1 illustrates four aspects for processing and embedding. The aspects illustrated in FIG. 1 are examples, Audio/Background Music embedding 105, Image/Video embedding with temporal understanding 106, Text/Caption/Scene Summation embedding 107, and other metadata (sentiment profanity) 108. In practice, many more modes are contemplated. For example, location, time of day, weather, genre, etc.

The extraction frame level detail may include objects, logos, locations, sentiment, action detection, scene summarizer, etc. All the information is then encoded using an embedding model for every scene and a vector search index for each scene is then built. This allows for free-form, contextual, and detailed video indexing/searches for example the metadata for “a romantic scene with a glass of wine by a lake” can be easily identified.

The embeddings are provided to an embedding aggregator 109 to generate aggregated embeddings 110. The aggregated embeddings may be stored in an embedding database 111.

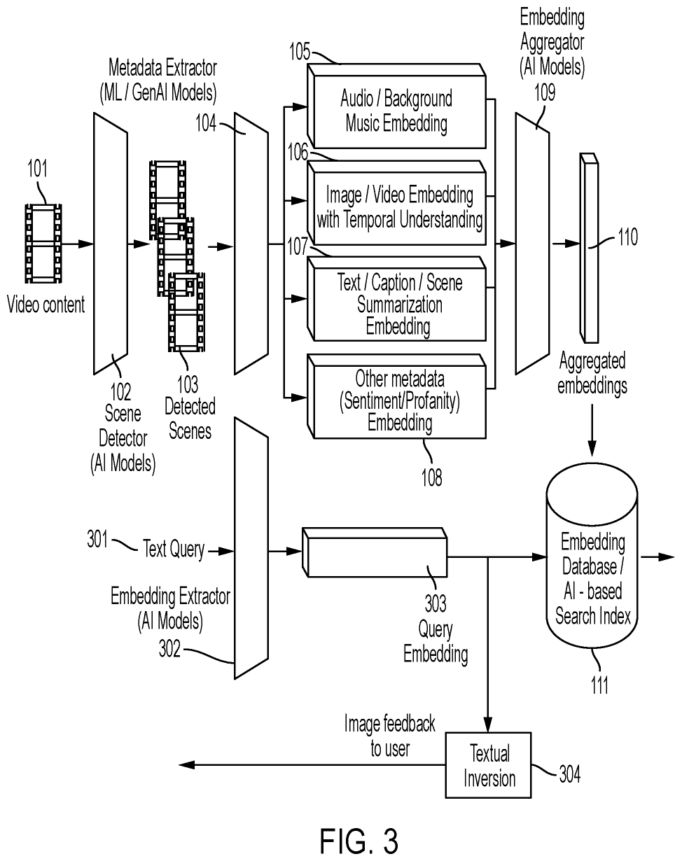

FIG. 3 shows a text-based query system for searching a database of video content metadata. As shown in FIG. 3, the metadata obtained by multimodal extraction, as shown in FIGS. 1 and 2, may be generated in advance and stored in a database. Alternatively, the query may be formulated as described herein and applied against a stream of multimodal extracted metadata in real-time or near real-time.

A text query 301 is encoded by embedding extractor 302. The query mode must correspond to one of the mode embeddings used to extract metadata. While the contemplated search is presented as text, the text can be used to search text-compatible modal extractions.

In its simplest form, the text query can search for corresponding text appearing in the content. The query embedding 303 (SG: The following description is of the text query searching across multiple embedding modes. Please let me know how this is done (or if something different is happening.)) creates a search vector across text-compatible modes. For another example, the location mode may be based on image recognition and if successful may recognize a city. Many cities have unique landmarks that may appear in the content and be recognizable. For example, landmarks like the Arc de Triomphe, the Louvre, or Eiffel Tower signify Paris France; the Empire State Building, UN, or Radio City signify New York.

The query embedding 303 is used to generate a search vector to be applied against the extractions used to index the content in order to find similar embeddings and the relevant scenes are returned (or identified). This allows for free-form, contextual, and detailed video searches, for example, “a romantic scene with a glass of wine by a lake” can be easily searched. Such searches can be used to identify occurrences in the video content, stored or streamed.

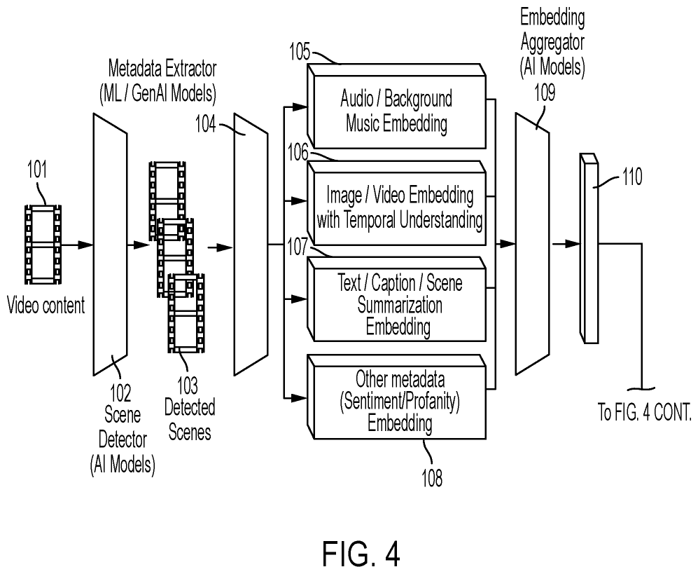

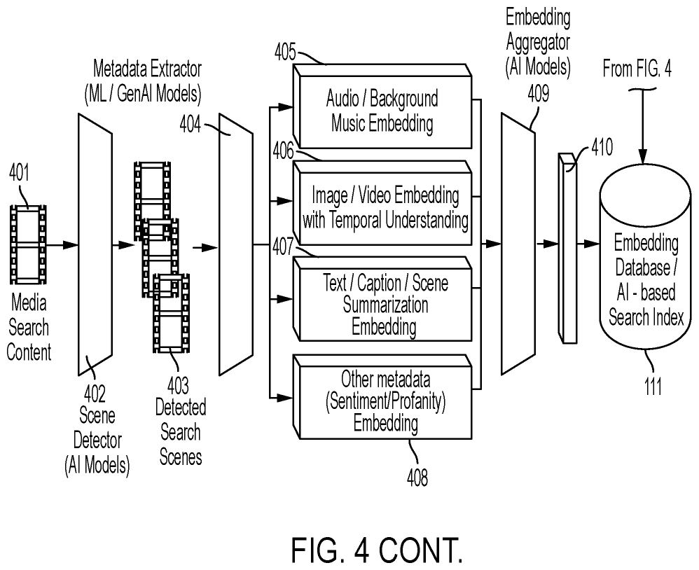

FIG. 4 shows an embodiment of a system that includes a multimodal metadata extractor for video content and a structure for searching and/or identifying content using video, image, audio and/or text queries. This system allows a user to identify video content that is close to or compatible with other creative content rather than requiring a text-based search as shown in FIG. 3. The system includes sub-system 400 for establishing a search vector 10. The search vector may be applied against an index database for a library of video content. The same search vector may be applied against a stream of video content.

The application may be useful for a system that intends to identify conditions that may present themselves in a live video stream. For example, in a security system, a user may wish to search for a particular occurrence, for example, a person or vehicle entering a gate or checkpoint and proceeding to a location other than a security office. The search content may be a staged video of a person or vehicle entering through a checkpoint and proceeding to unauthorized locations rather than a security office. The search may also be conducted by using video content of expected behaviors and searching for sequences that do not correlate to the expected behaviors.

Using or formulating explicit text queries to search for suitable shots in content, the system allows for free-form text, audio, video/image, music, and other inputs as queries. Another use case might be in the situation where an advertiser could use its own creative to select the best place in content to serve it. For example, during a TV program or movie that is streaming or broadcast, the advertiser could identify the correct time to insert its ad. There is no need for formulating explicit textual prompts or queries to find suitable shots for placing ads.

The search vector may be formulated using different modalities embedded using the same foundational models used to index the content stream. These embeddings can then be used to search the content for the highest similarities. The results can be aggregated post or pre-searched. The embeddings for different modalities can also be used to get a single representation using contrastive learning frameworks.

The search content input 401 is provided to a scene detector 402 operating in the same fashion as scene detector 102. Scene detector 402 may however be simplified to the extent that the application permits restricting video content search terms to a single shot or at least to an appropriately limited duration or complexity.

To the extent that the application permits multiple scenes in a video search, the scene detector may be considered to create multiple search terms. The system may be configured to cause a multi-scene search to look for content that includes each of the scenes, any of the scenes, or two or more of the scenes within a temporal limit. The scene boundaries define the detected scene 403. The detected scenes 403 are provided to a metadata extractor 404. The metadata extractor 404 may consider the content of the scenes individually according to one or more of the selected aspects anticipated to be potentially present in the content. FIG. 4 illustrates four aspects of search content processing and embedding. The aspects illustrated in FIG. 4 are examples. Audio/Background Music embedding 405, Image/Video embedding with temporal understanding 406, Text/Caption/Scene Summation embedding 407, and other metadata (sentiment profanity) 408. Many more modes are possible, however, they may not be needed for a video content search application, depending on the objective of the contemplated search. The search term embeddings may be provided to an embedding aggregator 409 to generate aggregated search embeddings 410 for use as a search vector against content embeddings.

As shown in FIG. 4, the metadata obtained by multimodal extraction, as shown in FIGS. 1 and 2, may be generated in advance and stored in a database. Alternatively, the query may be formulated as described herein and applied against a stream of multimodal extracted metadata in real-time or near real-time. This system allows a user to identify video content that is close to or compatible with other creative content rather than requiring a text-based search as shown in U.S. patent application Ser. No. ______, Attorney Docket No. 169004, and as illustrated in FIG. 3. The system includes a sub-system 400 for establishing a search vector 410. The search vector may be applied against an index database for a library of video content. The same search vector may be applied against a stream of video content.

The techniques, processes, and apparatus described may be utilized to control the operation of any device and conserve the use of resources based on conditions detected or applicable to the device or otherwise made available for further processing.

The system is described in detail with respect to preferred embodiments, and it will now be apparent from the foregoing to those skilled in the art that changes and modifications may be made without departing from the invention in its broader aspects, and the invention, therefore, as defined in the claims, is intended to cover all such changes and modifications that fall within the true spirit of the invention.

Thus, specific apparatus for and methods of metadata extraction have been disclosed. It should be apparent, however, to those skilled in the art that many more modifications besides those already described are possible without departing from the inventive concepts herein. The inventive subject matter, therefore, is not to be restricted except in the spirit of the disclosure. Moreover, in interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

1. A system for contextual matching content based on multimodal metadata extraction generated by processing one or more scenes to extract metadata corresponding to multiple extraction modes, and an embedding model for each extraction wherein an aggregated embedding model responsive to said metadata embeddings formulates an aggregated embedding comprising:
an embedding extractor responsive to a content input with an embedding model coordinated with said embedding model for one or more of said embedding modes; wherein said embeddings are in the form of a vector, and
a vector comparison processor for determining the distance between the query vector and a vector representing said aggregated embedding.

2. The system for contextual matching content according to claim 1 wherein said coordination between embedding models is established by training.

3. The system for contextual matching content according to claim 1 wherein said coordination between embedding models is established by using a common foundational model.

4. The system for contextual matching content according to claim 1 wherein said embedding extractor accepts video content having more than one scene and further comprises a scene detector that determines scene boundaries wherein said embedding extractor operates on each scene to generate a search vector for each scene.

5. The system for contextual matching content according to claim 1 further comprises a logic function for said search vectors according to specific logic.
